(19) United States
(12) Patent Application Publication
(10) Pub. No.: US 2008/0061943 A1
(43) Pub. Date: Mar. 13, 2008

(54) RFID systems and methods of operating the same in power-saving modes

(76) Inventors: Ke-Li Wu, Hong Kong (CN); Hong-Yang Wang, Xi'an (CN); Da-Cheng Wei, Guangzhou (CN); Ying-Zeng Yin, Xi'an (CN); Wai-Cheung Tang, Ontario (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/504,823

(22) Filed: Aug. 11, 2006

(51) Int. Cl. H04Q 5/22

(52) U.S. Cl. 340/10.33; 340/10.1; 340/572.1; 455/343.1

(57) ABSTRACT

A method of operating an RFID system and an RFID system in a power-saving mode are disclosed. In one embodiment, the system comprises at least one reader and at least one tag. The at least one reader may transmit a wake-up signal to the at least one tag when turning on, and the at least one tag stays alternatively in a sniff mode and a sleep mode at an alternative period before receiving the wake-up signal. The method may comprise modulating the wake-up signal by using N time markers.

### TECHNICAL FIELD OF THE INVENTION

The present invention relates generally to an RFID system including one or more readers and one or more tags or transponders, especially, to an RFID system and a method for operating an RFID system in a power-saving mode.

### BACKGROUND OF THE INVENTION

Among various problems, power-saving is one of the most prominent issues for a viable business scenario. Every active tag needs to be powered by a battery and all communications between a tag and a reader consume energy from battery. Most of applications of an active RFID system need a long reading and writing distance between readers and tags. The “long distance” means that tags must be highly sensitive so that they are able to receive signals from and transmit signals to readers.

To save power, a rudimentary method is to minimize the operating time of a tag. In a practical active RFID implementation, a tag alternatively stays in a sniff mode and a sleep mode for most of time and is woken up to exchange information with the relevant reader upon receiving a wake-up signal from a reader.

The known RFID system is in operation under ISO18000-7 protocol, in which the wake-up signal is a single tone signal. A reader transmits a wake-up signal periodically. Even though commands are transmitted from the reader to a tag, the transmitting will be interrupted in order to keep sending wake-up signals as required under the protocol. A wake-up signal is a single tone signal near a center frequency. Each wake-up signal will last for a few seconds to ensure tags to capture it. The exact duration and period of a wake-up signal depends on specific applications. Appended to each wake-up signal is a data period for communicating with tags. On the tag side, each tag alternatively stays in a sniff mode and a sleep mode. If the tag in the sniff mode could capture a wake-up signal, the tag will be immediately turned to receiving mode for receiving commands from a reader which transmits the wake-up signal. FIG. 1 illustrates the timing sequence of a wake-up process of a tag under ISO18000-7 protocol.

As illustrated in FIG. 1, a tag 120 is in a sleep mode and a sniff mode alternatively. A reader 110 transmits periodically a wake-up signal and commands (hereinafter referred to as “valid data”). Under the known protocol, when a tag is in the sniff mode, it may capture a wake-up signal from a reader 110 if there exists such a wake-up signal. Once the tag 120 captures a wake-up signal from a reader 110, the tag 120 will stay in a receiving mode for awaiting valid data.

As shown in FIG. 1, according to ISO18000-7 protocol, when the tag 120 is in a sniff mode 121, no wake-up signal is available. The tag 120 will return in a sleep mode. When the timing of the next sniff mode is coming, the tag could capture a wake-up signal during the sniff mode period 122. After then, the tag 120 stays in a receiving mode until all valid data are received or data exchange between the tag 120 and the reader 110 is completed during the period 124. Such a wake-up and waiting process is called as a wake-up-and-waiting scheme.

Although such a wake-up-and-waiting scheme can save a lot of battery power, the tag will waste the energy of battery during the period 123, which is an interval between the end of the sniff mode 122 and the beginning of the period 124.

### SUMMARY OF CERTAIN INVENTIVE ASPECTS

One aspect of the present invention provides an RFID system with the capability of effectively saving power of battery of a tag. A Method of operating the system is also provided.

Another aspect of the invention provides a method of operating an RFID system comprising at least one reader and at least one tag is proposed, in which the at least one reader transmits a wake-up signal to the at least one tag when turning on, and the at least one tag stays alternatively in a sniff mode and a sleep mode at an alternative period before receiving the wake-up signal. In one embodiment, the method comprises: i) modulating the wake-up signal by using N time markers, ii) capturing one of time markers within the wake-up signal during a period when the at least one tag stays in the sniff mode, iii) determining a time length T between the captured time marker and the end of the wake-up signal, iv) entering the at least one tag into the sleep mode at the end of the period for capturing the time marker, v) enabling the tag from the sleep mode to a receiving mode at latest when the determined time length T lapses for receiving valid data from the at least one reader or exchanging data with the at least one reader and vi) restoring the tag to the state of staying alternatively in a sniff mode and a sleep mode after the valid data are received or the data exchange is completed.

In one embodiment, a guard time may be set prior to the end of each of the time length and enable the tag at the guard time for the purpose of reliability.

Another aspect of the present invention provides a scheme for adaptively controlling the transmitting power of a tag according to a distance between the tag and its corresponding reader for the purpose of saving power.

Another aspect of the present invention provides a scheme for adjusting the sniffing period according to the frequency of a tag being woken. The lower the frequency is, the longer the period will be. In this way, the power will be saved, especially, for those rarely used tags.

Another aspect of the present invention provides a system for implementing the method mentioned above. In one embodiment, the system comprises at least one reader and at least one tag, in which the at least one reader transmits a wake-up signal to the at least one tag when turning on, and the at least one tag stays alternatively in a sniff mode and a sleep mode at an alternative period before receiving the wake-up signal. The at least one reader may further comprise a modulator configured to modulate the wake-up signal by using N time markers and a transceiver configured to transmit the wake-up signal to the at least one tag and communicate with the at least one tag. The at least one tag may comprise a transceiver configured to capture one of time markers within the wake-up signal during a period when the of the wake-up signal, and a controller configured to put the tag into a sleep mode at the end of the period for capturing the time marker, turn the at least one tag from the sleep mode into a receiving mode at latest when the determined time length lapses for receiving valid data or exchanging data with the at least one reader, and restore the at least one tag to a state of staying alternatively in a sniff mode and a sleep mode at an alternative period after the valid data are received or the data exchange is completed.

In one embodiment, the present system further comprises a module configured to set a guard time prior to the end of the time length to enable the tag at the guard time.

In one embodiment, the system may comprise a module configured to determine the strength of the wake-up signal and preset the determined strength as a threshold and a module configured to adapt the strength of a signal to be transmitted from the at least one tag to the threshold.

In one embodiment, the system may comprise a module configured to determine and record a frequency of the at least one tag being woken and a module configured to adapt the alternative period according to the frequency.

It is understood that the above optional means may also be directly incorporated into the system under the current protocol like ISO18000-7 for power-saving.

It is understandable for those skilled in the art that the above optional modules may be also incorporated into a conventional RFID system solely, which will be especially useful for those rarely woken tags for power-saving.

Still another aspect of the present invention proposes a system capable of making a switch between two available protocols. In one embodiment, the system further comprises a module configured to switch the operation of the tag from one protocol to another protocol according to applications. The operation of the tag may be switched to a power-saving protocol where a time marker is captured from a wake-up signal. In one embodiment, the operation of the tag is switched to ISO18000-7 protocol where a wake-up signal is a single protocol according to applications. The operation of the tag may be switched to a power-saving protocol where a time marker is captured from a wake-up signal. In one embodiment, the operation of the tag is switched to ISO18000-7 protocol where a wake-up signal is a single tone signal.

In order to deal with two different tags in the same coverage, the at least one reader can switch to two different protocols alternatively. Or the reader can work, for most of time, in one protocol and occasionally turns to the other protocol mode to check if other type of tags also exist, and then switch back to the original protocol.

In embodiments of the present invention, any of the systems and methods is generic and not subject to any particular realization. Embodiments of the present invention will be described with reference to the following drawings.

### BRIEF DESCRIPTION OF THE DRAWINGS

FIG. 1 is a time sequence diagram of the wake-up and sniff scheme in the prior art;

FIG. 2 is a time sequence diagram of the process of a wake-up and sniff scheme according to one embodiment of the present invention;

FIG. 3 is a flow chart showing an exemplary operation of an RFID system using the scheme in FIG. 2;

FIG. 4 shows the relationship between a measured RSS and a distance; and

FIG. 5 is a flow chat of the process for switching automatically between two available protocols.

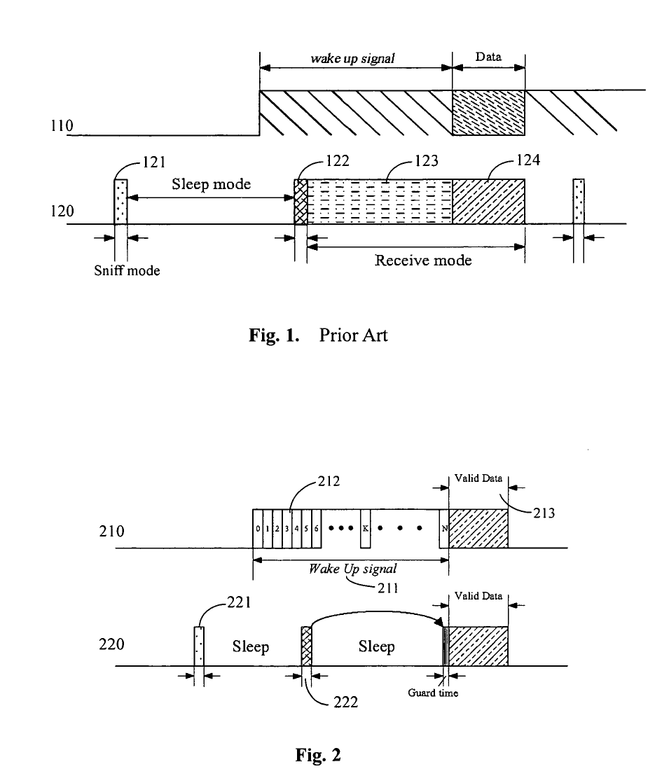

### DETAILED DESCRIPTION OF CERTAIN INVENTIVE EMBODIMENTS

FIG. 2 is a time sequence diagram showing the process of a wake-up and sniff scheme of the RFID system of one embodiment according to the present invention. The embodiment is given in respect of one reader and one tag for easy illustration. However, it is understood for one of ordinary skill in the art that the concept of the present invention should be applied to a system which includes more than one reader and more than one tag.

As shown in FIG. 2, a tag 220, as usual, stays in a sleep mode and a sniff mode alternatively. A reader 210 transmits a wake-up signal 211 and valid data 213 when turning on. Compared with the prior art, the wake-up signal 211 is modulated by a plurality of time markers 212 according to one embodiment of the present invention. In FIG. 2, (N+1) time markers 0, 1, 2, . . . , K, . . . N are stamped into the wake-up signal 211, wherein N is 0 or an integer other than 0. In this way, and the wake-up signal is composed of N contiguous time pulses (hereinafter referred to as “time marker”). The modulation scheme may be an amplitude modulation (AM), a frequency modulation (FM) and a phase modulation (PM). Each of the N+1 time markers is transmitted by the reader as a wake-up signal.

When the tag is in a sniff mode 221, since no wake-up signal is available, the tag returns to a sleep mode. When the tag turns to a sniff mode again, a wake-up signal is coming from the reader 210. In this case, one of the time markers, such as marker K, will be captured. Subsequently, a calculator (not shown) of the tag will determine when the reader will start sending valid data, namely, a time length between the time for capturing the mark k and the time for starting to transmit valid data. For example, if every marker is stamped at the same interval along the entire duration of a wake-up signal, the reader 210 will begin to send valid data after a time length T lapses, where T=(N+1−K)×ΔT, wherein ΔT is equal to the width of a time marker. After obtaining the time length T, the tag 220 stores the time length T and will get into a sleep mode immediately for the time length T. A microprocessor or a controller (not shown) of the system can control the tag to be woken up at the end of the time length T, namely, at the time when the reader 210 starts to transmit valid data. Since a tag needs to reserve a guard time to ensure the function on the tag is stable before it gets into a receiving mode to receive the valid data or exchange data with the reader, the duration of the tag in the sleep mode shall be T_{g}=((N+1−K)×ΔT−Guard Time).

Thus, compared with the scheme of ISO18000-7, the wake-up scheme according to one embodiment of the present invention can significantly save energy for a tag, particularly for those frequently used tags which will be woken up hundreds of times a day. For example, if a tag is woken up 100 times a day and each wake-up signal lasts one second, a tag will waste about 0.5×100 seconds working period averagely before receiving valid data or exchanging data. The wake-up scheme according to one embodiment of the present invention can alleviate this problem.

In addition to power-saving, the modulated wake-up signal used in one embodiment of the invention also leads to an attractive anti-interference feature. In reality, there are tremendous RF interferences in the space and some of them are very strong. Using a modulated wake-up signal can prevent tags from being woken up by a spurious wake-up signal. Only when a spurious wake-up signal happens to be the same as a modulated wake-up signals as provided in one embodiment of the invention, which is almost impossible, can tags be woken. Thus, using a modulated wake-up signal enhances the reliability of an active RFID system and extends the effective working distance thereof if the energy of a tag is kept in a state of satiations.

Optionally, the reader 210 comprises a switcher (not shown) which can switch the operation of the reader from one protocol to another protocol according to applications. For example, the switcher can switch alternatively the reader to operate under two different protocols; or the reader can work for most of time in the protocol according to one embodiment of the present invention, and the switcher can switch the reader periodically to a conventional protocol mode to check if a conventional tag also exists and then switch the reader back to the protocol according to one embodiment of the present invention.

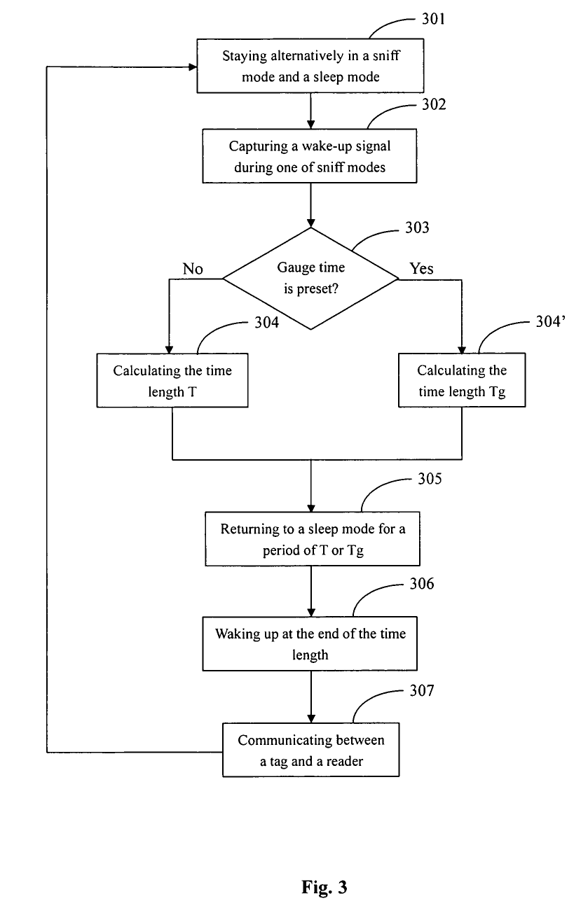

Now an illustration of the operation of the tag of the RFID system according to one embodiment of the present invention is exemplified by referring to FIG. 3. All the illustration is for explanation of the concept of the present invention.

As shown in FIG. 3, the tag is alternatively in a sniff mode and a sleep mode (step 301). A wake-up signal from the reader is captured during one of sniff modes (step 302). As stated above, the wake-up signal according to one embodiment of the present invention includes a plurality of time markers. So, one of time markers is captured in step 302, as a matter of fact. Subsequently, the tag determines whether a guard time is preset into the tag or the reader for guaranteeing communications between the tag and the reader (step 303). If no, the tag calculates the time length T in step 304. Or, if yes, the tag will calculate the time length T_{g} in step 304′.

The tag will return to the sleep mode after informing its own microprocessor (not shown) to store the calculated time length T or T_{g}, and be woken up at the end of the stored time length T or T_{g} in step 306.

After woken up, the tag is in a receiving mode for communicating with the reader in step 307 and enters into its normal state, namely, staying alternatively in a sniff mode and a sleep mode once the communication is completed.

For most of active RFID systems, the communication distance between a tag and a reader can be more than 100 meters. However, a tag is not always away from a reader as far as 100 m. For example, the distance between a tag and a reader may be less than 20 meters. For such a short distance, lower output power from the tag would be pertinent for power-saving. Thus, another adaptive power control scheme is proposed in one embodiment of invention, which may be used in combination with other schemes or separately, depending on the actual applications. According to the proposed adaptive power control scheme, when a tag is close to a reader, its output power will be automatically reduced for the purpose of power saving. On the contrary, when a tag is far from a reader but within a predetermined range, its output power will be increased to ensure the communication between the tag and the corresponding reader.

Specifically, the scheme is carried out with the following steps. It is understood, the output power of a tag will be preset so strong that the communication at the longest communication distance could be successful.

When the tag captures a wake-up signal at a first distance which is shorter than the longest distance, it detects the received signal strength (RSS), and determines whether the captured RSS is the same as the preset strongest one. If the RSS is less than the preset one, the captured RSS will be preset as a threshold, which shows that, as long as the distance between the tag and the reader equals to or is less than the first distance, the power of output of the tag should be reduced from the strongest to the same as the threshold.

Further, the strength of a signal will be affected by the path loss and fading property in a given environment. The total attenuation is the sum of the path loss and the fading loss, if other factors affecting the strength of a signal are omitted. The path loss of a wireless uplink channel (from a tag to a reader) is the same as that in a downlink channel (from a reader to a tag). Thus, a tag can estimate the total attenuation after it gets the strength of a received signal from a reader, given that the transmitted power keeps constant, and thereby determine how to adjust its output power for the purpose of power saving.

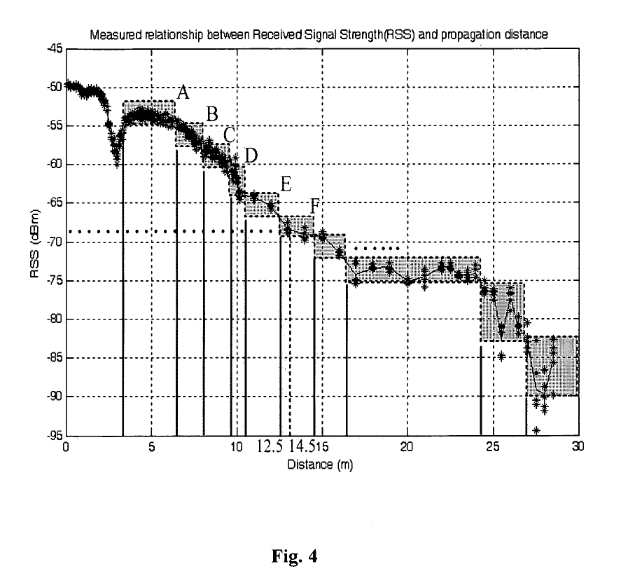

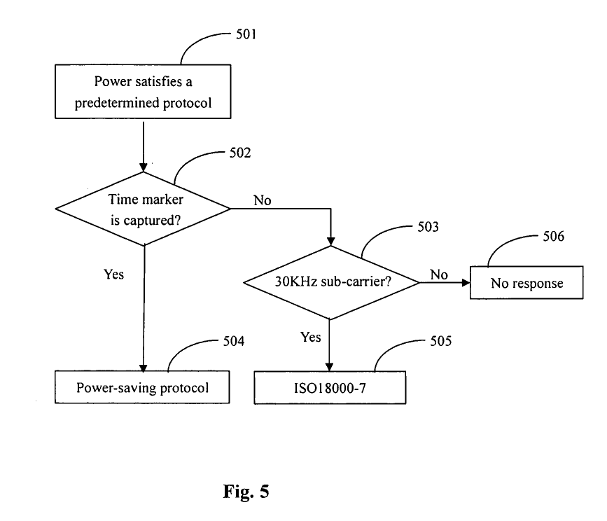

As shown in FIG. 4, given that a transmitting Effective Isotropic Radiated Power (EIRP) from a reader is 5.6 dBm, the power of output of a tag will be predetermined as 5.6 dBm due to the symmetry of wireless channels. In fact, the received power by a tag varies with the change of the distance between the tag and the reader. For example, the received power of a tag at location A, B, C, D, E and F are −54 dBm, −57 dBm, −59 dBm, −62 dBm, −66 dBm and −70 dBm, respectively.

Assuming that the sensitivity of the reader is of −100 dBm, when a tag is at the location A, B, C, D, E and F, respectively, as long as the received signal strength is greater than −100 dBm, there is no need for a tag to output the predetermined power of 5.6 dBm. Instead, by using the proposed adaptive power control scheme, the output power of the tag at these six locations may be −40.4 dBm, −37.4 dBm, −35.4 dBm, −32.4 dBm, −28.4 dBm and −24.4 dBm, respectively, to satisfy the reliability of communication between the tag and the reader. Thus, the power received by the reader is still −100 dBm, but the energy of a tag could be saved significantly.

It is noted that, when the communication between a reader and a tag cannot be successfully performed, the tag should adaptively increase its output power until the communication between tags and the reader successes. That is to say, the output power of a tag is dynamically adjusted to ensure a good communication.

As for active RFID tags operating under ISO18000-7 protocol, especially for those tags that are not used frequently, most of the energy of battery will run out due to its alternatively and continually switching between a sniff mode to a sleep mode. Thus, adjustment of the period of the alternative period will also benefit to save power. From this point of view, the present inventors further propose the following scheme. It is understood that this scheme may be applied in combining with the above mentioned power-saving schemes or independently.

First, the tag records the frequency of the tag being woken in the memory. The microprocessor of the tag is configured to adjust the alternative period according to the frequency. The lower the stored frequency is, the longer the alternative period should be. Users could preset an upper threshold and a lower threshold for the frequency. If the frequency of a tag being woken is less than said preset lower threshold, the alternative period should be increased. Say, the tag will stay in a sniff mode after a longer period in a sleep mode. To the contrary, if the frequency is higher than the preset upper threshold, which means the tag is used often, the period during which the tag is in a sleep mode will be shorten in hopes of not missing any desirable wake-up signal.

According to one embodiment of the present invention, another embodiment shows a process of automatically switching between two protocols, which enable one RFID system to operate at two protocols.

In order to make an RFID system according to one embodiment of the present invention compatible to ISO18000-7 protocol, an active RFID tag preferably comprises a switcher which can automatically determine whether a wake-up signal captured by the tag is the one under the ISO18000-7 protocol or adaptable to one embodiment of the present invention (which may be taken as a new protocol of active RFID system in future, hereinafter, it will be referred to as “power-saving protocol”). The switcher will enable the tag to switch to an appropriate protocol according to the difference between wake-up signals under two protocols.

It is not difficult to distinguish the wake-up signal under the ISO18000-7 protocol from that under one embodiment of the present invention since these two kinds of wake-up signals are totally different in time domain and in frequency domain. In ISO18000-7 protocol, the wake-up signal is an f₀±30 KHz sub-carrier which is near the operating frequency. In the proposed power saving protocol, the wake-up signal is a modulated RF signal which incorporates time markers.

When a wake-up signal is captured during the period of a tag staying at a sniff mode, the switcher on a tag will firstly determine which protocol the captured wake-up signal belongs to. Since the demodulated 30 KHz sub-carrier of the wake-up signal under ISO18000-7 protocol is a DC signal, it is easy for a tag to be understood. Thus, the tag will automatically switch to ISO18000-7 and begin to receive data under ISO18000-7 protocol. Otherwise, if the tag could sense a time marker from the captured wake-up signal, it will operate according to the power saving protocol.

FIG. 5 is a flow chat of a process of automatically switching between two protocols. For example, when the predetermined protocol is the known ISO18000-7, the RSS should be at 30 KHz. As shown in FIG. 5, a tag identifies whether the energy centered on the carrier frequency is enough according to received signal strength (RSS) (step 501), namely, whether the power of RSS satisfies with a predetermined protocol. If the power is less than the predetermined threshold, the tag will not be woken up. Otherwise, the tag will determine whether any time marker is available (step 502). If a time marker is captured, the tag can switch to the proposed “power-saving protocol” for further operation (step 504). Otherwise, the system will determine whether the sub-carrier is 30 KHz (step 503). If yes, continually operates under the current ISO 18000-7 protocol (step 505). Otherwise, no response will be generated from (step 506).

While the forgoing embodiments of the invention have been described and shown, it is understood that alternatives and modifications, such as those suggested and others, may be made thereto which fall within the scope of the invention.

1. A method of operating an RFID system comprising at least one reader and at least one tag, wherein said at least one reader transmits a wake-up signal to said at least one tag when turning on, and said at least one tag stays alternatively in a sniff mode and a sleep mode at an alternative period before receiving said wake-up signal, the method comprising
modulating said wake-up signal by using N time markers;
capturing said one of time markers within said wake-up signal during a period when said at least one tag stays in said sniff mode;
determining a time length T between said captured time marker and the end of said wake-up signal;
entering said at least one tag into said sleep mode at the end of said period for capturing said time marker;
enabling the tag from said sleep mode to a receiving mode at latest when said determined time length T lapses for receiving valid data from said at least one reader or exchanging data with said at least one reader; and
restoring the tag to the state of staying alternatively in a sniff mode and a sleep mode turning after said valid data are received or said data exchange is completed.

2. The method of claim 1, further comprising setting a guard time prior to the end of the time length T.

3. The method of claim 2, wherein said at least one tag is enabled in advance of the guard time.

4. The method of claim 1, further comprising:
setting the strength of said wake-up signal as a threshold; and
adapting the strength of a signal to be transmitted from said at least one tag to said threshold.

5. The method of claim 1, further comprising:
recording a frequency of said at least one tag being woken; and
adapting the alternative period of said at least one tag between the sniff mode and the sleep mode according to said frequency.

6. The method of claim 5, wherein the alternative period is increased if said frequency is less than a first predetermined threshold.

7. The method of claim 5, wherein the period is shrunk if said frequency is larger than a second predetermined threshold.

8. The method of claim 1, wherein said N time markers are stamped into the duration of said wake-up signal at a regular distance to divide said wake up signal into N intervals.

9. The method of claim 1, wherein said N time markers are stamped into the duration of said wake up signal at a variable distance.

10. An RFID system comprising at least one reader and at least one tag, wherein said at least one reader transmits a wake-up signal to said at least one tag when turning on, and said at least one tag stays alternatively in a sniff mode and a sleep mode at an alternative period before receiving said wake-up signal,
wherein said at least one reader comprises:
a modulator configured to modulate said wake-up signal by using N time markers; and
a transceiver configured to transmit a wake-up signal to said at least one tag and communicate with said at least one tag,
wherein said at least one tag comprises:
a transceiver configured to capture said one of time markers within said wake-up signal during a period when said at least one tag stays in said sniff mode and communicate with said at least one reader;
a calculator configured to determine a time length between said captured time marker and the end of said wake-up signal; and
a controller configured to put said at least one tag into a sleep mode at the end of said period for capturing said time marker, turn said at least one tag from said sleep mode into a receiving mode at latest when said determined time length lapses for receiving valid data or exchanging data with said at least one reader, and restore said at least one tag to a state of staying alternatively in a sniff mode and a sleep mode at an alternative period after said valid data are received or said data exchange is completed.

11. The system of claim 10, further comprising a module configured to set a guard time prior to the end of the time length.

12. The system of claim 11, wherein said tag is enabled in advance of the guard time.

13. The system of claim 10, wherein said tag further comprises:
a module configured to determine the strength of said wake-up signal and preset the determined strength as a threshold; and
a module configured to adapt the strength of a signal to be transmitted from said tag to said threshold.

14. The system of claim 10, wherein said tag further comprises:
a module configured to determine and record a frequency of the tag being woken; and
a module configured to adapt the alternative period according to said frequency.

15. The system of claim 10, wherein said tag further comprises a switcher configured to switch the operation of the tag from one protocol to another protocol according to applications.

16. The system of claim 15, wherein the operation of the tag is switched to a power-saving protocol where a time marker is captured from a wake-up signal.

17. The system of claim 15, wherein the operation of the tag is switched to ISO18000-7 protocol where a wake-up signal is a single tone signal.

18. The system of claim 10, wherein said at least one reader further comprises a switcher configured to switch the operation of the reader from one protocol to another protocol according to applications.

19. The system of claim 18, wherein said switcher can switch alternatively said at least one reader to operate under said two different protocols

20. The system of claim 18, wherein said at least one reader can work for most of time in one protocol, and said switcher can switch said at least one reader periodically to the other protocol mode to check if other type of tags also exist and then switch said at least one reader back to the original protocol.

21. An RFID system comprising at least one reader and at least one tag, wherein said at least one reader transmits a wake-up signal to said at least one tag when turning on, and said at least one tag stays alternatively in a sniff mode and a sleep mode at an alternative period before receiving said wake-up signal,
wherein said at least one reader comprises:
means for modulating said wake-up signal by using N time markers; and
means for transmitting a wake-up signal to said at least one tag and communicating with said at least one tag,
wherein said at least one tag comprises:
means for capturing said one of time markers within said wake-up signal during a period when said at least one tag stays in said sniff mode and communicating with said at least one reader;
means for determining a time length between said captured time marker and the end of said wake-up signal; and
means for putting said at least one tag into a sleep mode at the end of said period for capturing said time marker, turning said at least one tag from said sleep mode into a receiving mode at latest when said determined time length lapses for receiving valid data or exchanging data with said at least one reader, and restoring said at least one tag to a state of staying alternatively in a sniff mode and a sleep mode at an alternative period after said valid data are received or said data exchange is completed.
